(19) United States
(12) Patent Application Publication
(10) Pub. No.: US 2003/0032537 A1
(43) Pub. Date: Feb. 13, 2003

(54) Multi-tiered scoring head

(76) Inventor: David Lauderbaugh, Roswell, GA (US)

Correspondence Address: GARDNER GROFF, MEHRMAN & JOSEPHIC, P.C., Paper Mill Village, Building 23, 600 Village Trace, Suite 300, Marietta, GA, 30067, US

(21) Appl. No.: 09/925,698

(22) Filed: Aug. 9, 2001

(51) Int. Cl. B31F 1/08

(52) U.S. Cl. 493/59

(57) ABSTRACT

A multi-tiered scoring head that includes a scoring edge extending axially between first and second radial edges and a central tier extending axially from a central axis to a first flank. The scoring edge also includes a first face extending from the first flank to a second flank. The first face is located radially closer to the axis of rotation than the central tier. The scoring edge also includes a second face extending from the second flank to a third flank. The second face is located radially closer to the axis of rotation than the first face. The first beveled surface extends from the third flank to the first radial edge. In addition, the central tier extends axially from the central axis to a fourth flank. The scoring edge also includes a third face extending from the fourth flank to a fifth flank. The third face is located radially closer to the axis of rotation than the central tier. The scoring edge also includes a fourth face extending from the fifth flank to a sixth flank. The fourth face is located closer to the axis of rotation than the third face. The scoring edge also includes a second beveled surface extending from the sixth flank to the second radial edge.

### TECHNICAL FIELD

This invention relates generally to the corrugated board industry and, more particularly, relates to a corrugated board scoring head having a multi-tiered or stepped scoring edge profile.

### BACKGROUND OF THE INVENTION

For many decades, scoring heads have been used to impress score lines into corrugated board to facilitate folding the board into desired configurations, such as boxes. Proper score lines should be “crisp” in that the board immediately adjacent to the score line is not bent or rolled toward the score line. In addition, the scoring head should not tear, crack or cut the top liner of the board. A board with a “rolled” score line or torn, cracked or cut liner is weaker than a board with a crisp score line, and may be considered defective for many applications.

Despite many years of industry experience, conventional scoring heads still produce an unacceptable number of defective “rolled” score lines and torn, cracked or cut liners. These problems can be accentuated when the same scoring head is used to score corrugated board of varying thickness, such as single-wall, double-wall and triple-wall board. For example, a scoring head that effectively creates crisp score line in double-wall board may produce rolled score lines in single-wall board. Conversely, a scoring head that effectively creates create crisp score lines in single-wall board may tear, crack or cut the top liner when used on double-wall board. In general, a single scoring head that effectively creates crisp score lines in single-wall, double-wall and triple-wall board is not presently available. For this reason, the scoring heads often must be changed in response to changes in board thickness. Of course, changing the scoring heads, which slows production, is inconvenient and costly.

Therefore, there is a continuing need in the corrugated board industry for a scoring head that consistently creates crisp score lines in corrugated board of varying thickness, such as single-wall, double-wall and triple-wall board.

### SUMMARY OF THE INVENTION

The present invention meets the needs described above in a multi-tiered scoring head that includes multiple faces and one or more beveled surfaces. The scoring head may be symmetrical about a central axis. The multiple tiers of the scoring head allow the head to consistently create crisp score lines in corrugated board of varying thickness, such as single-wall, double-wall and triple-wall board. That is, the multi-tiered scoring head effectively avoids tearing, cracking or cutting the top liner, or creating rolled score lines, when used on corrugated board of varying thickness. Therefore, the same scoring head can be used to score single-wall, double-wall and triple-wall board.

Generally described, the invention includes scoring head configured for rotating about an axis of rotation and impressing score lines into corrugated board. The scoring head includes a scoring edge extending axially between first and second radial edges. The scoring edge includes a central tier extending axially from a central axis to a first flank. The scoring edge also includes a first face extending from the first flank to a second flank. The first face is located radially closer to the axis of rotation than the central tier. The scoring edge may also include a first beveled surface extending from the second flank to the first radial edge.

Alternatively, the scoring edge may also include a second face extending from the second flank to a third flank. The second face is then located radially closer to the axis of rotation than the first face. In this alternative, the first beveled surface extends from the third flank to the first radial edge.

In addition, the central tier extends axially from the central axis to a fourth flank. The scoring edge typically includes a third face extending from the fourth flank to a fifth flank. The third face is located radially closer to the axis of rotation than the central tier. The scoring edge may also include a second beveled surface extending from the fifth flank to the second radial edge.

Alternatively, the scoring edge may also include a fourth face extending from the fifth flank to a sixth flank. The fourth face is then located closer to the axis of rotation than the third face. In this alternative, the scoring edge also includes a second beveled surface extending from the sixth flank to the second radial edge.

The central tier is typically symmetrical about the central axis. In addition, the central tier may define a scoring surface that is substantially perpendicular to the central radial axis. Likewise, the first, second, third and fourth faces may each define a scoring surface that is substantially perpendicular to the central radial axis. In addition, each flank may define a substantially radial surface.

In a prerferred embodiment, the multi-tiered scoring head includes a scoring edge extending axially between first and second radial edges and a central tier extending axially from a central axis to a first flank. The scoring edge also includes a first face extending from the first flank to a second flank. The first face is located radially closer to the axis of rotation than the central tier. The scoring edge also includes a second face extending from the second flank to a third flank. The second face is located radially closer to the axis of rotation than the first face. A first beveled surface extends from the third flank to the first radial edge. In addition, the central tier extends axially from the central axis to a fourth flank. The scoring edge also includes a third face extending from the fourth flank to a fifth flank. The third face is located radially closer to the axis of rotation than the central tier. The scoring edge also includes a fourth face extending from the fifth flank to a sixth flank. The fourth face is located closer to the axis of rotation than the third face. The scoring edge also includes a second beveled surface extending from the sixth flank to the second radial edge.

In another embodiment, the multi-tiered scoring head includes a scoring edge extending axially between first and second radial edges and a central tier extending axially from a central axis to a first flank. The scoring edge also includes a first face extending from the first flank to a second flank. The first face is located radially closer to the axis of rotation than the central tier. A first beveled surface extends from the second flank to the first radial edge. In addition, the central tier extends axially from the central axis to a third flank. The scoring edge also includes a second face extending from the third flank to a fourth flank. The second face is located radially closer to the axis of rotation than the central tier. The scoring edge also includes a second beveled surface extending from the fourth flank to the second radial edge.

The specific configuration of a preferred embodiment of the multi-tiered scoring head will become apparent from the following detailed description and the appended drawings and claims.

### BRIEF DESCRIPTION OF THE DRAWINGS

FIG. 1 is a front view of a scoring head and anvil for impressing score lines into corrugated board.

FIG. 2 is a side view of a scoring head and anvil for impressing score lines into corrugated board.

FIG. 3 is a top view of a scoring head and anvil for impressing score lines into corrugated board.

FIG. 4 is a front view of a scoring head for impressing score lines into corrugated board.

FIG. 5 is a front view of the scoring edge for impressing score lines into corrugated board.

FIG. 6 is a front view of a preferred scoring head showing the height of the scoring head.

FIG. 7 is a front view of a preferred scoring head showing dimensions defining the scoring profile.

FIG. 8 is a front view of the preferred scoring head showing additional dimensions defining the scoring profile.

FIG. 9 is a front view of an alternative profile for a scoring head for impressing score lines into corrugated board.

FIG. 10 is a front view of another alternative profile for a scoring head for impressing score lines into corrugated board.

### DETAILED DESCRIPTION OF THE EMBODIMENTS

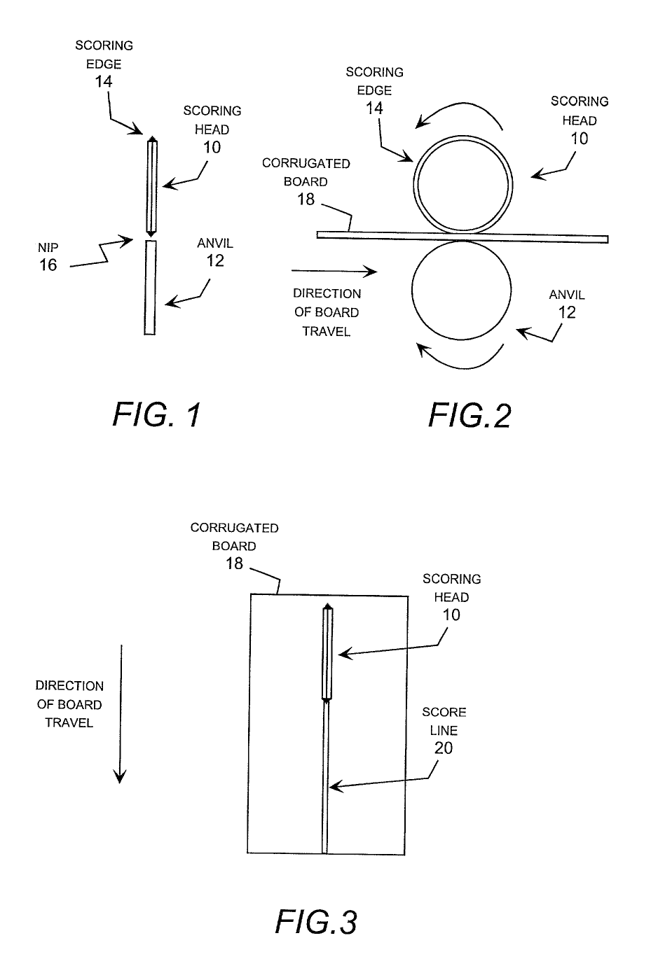

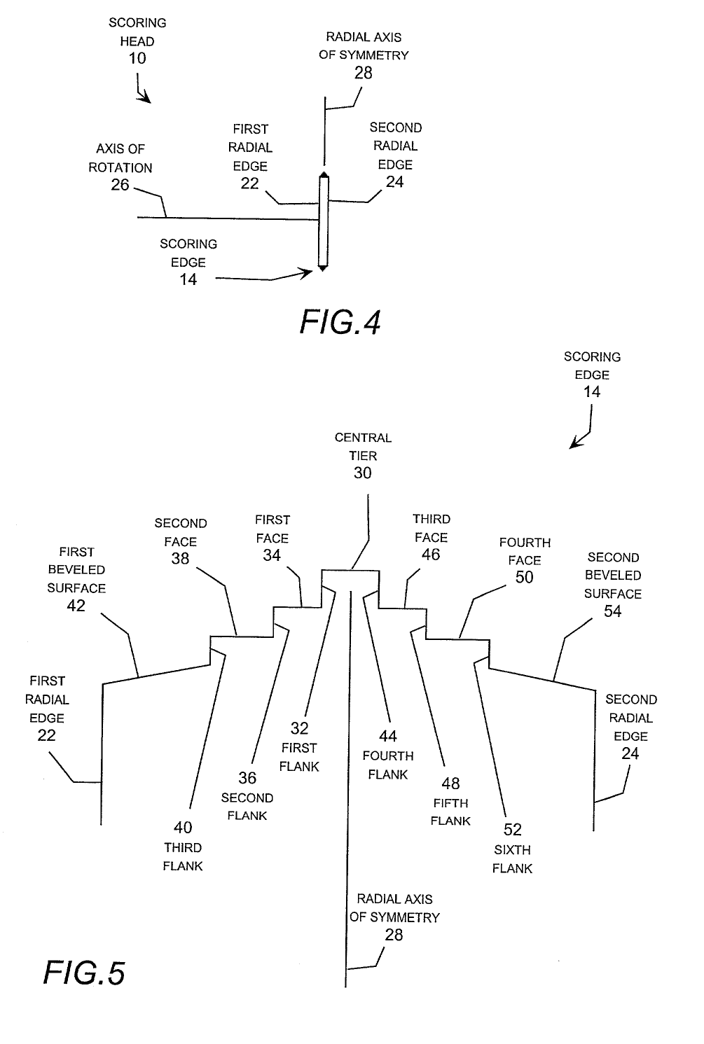

Turning now to the drawings, in which like numerals refer to like elements throughout the several figures, FIG. 1 is a front view of a scoring head 10 and anvil 12 for impressing score lines into corrugated board. FIG. 2 is a corresponding side view, and FIG. 3 is a corresponding top view. The scoring head 10 includes a scoring edge 14 for impressing a score line 20 into corrugated board 18 passing through a nip 16 between the scoring head 10 and anvil 12. FIG. 4 is a front view of the scoring head 10, which includes a scoring edge 14 located between a first radial edge 22 and a second radial edge 24. The scoring head 10 rotates about an axis of rotation 26, and is typically symmetrical about a radial axis of symmetry 28. Although the general features and operation of the scoring head 10 described above are well known in the art, the multi-tiered profile of the scoring edge 14 represents a significant improvement in scoring head technology.

FIG. 5 is a front view of the scoring edge 14 illustrating the inventive multi-tiered profile. Although the preferred scoring edge profile is symmetrical about the radial axis of symmetry 28, non-symmetrical multi-tiered scoring edge profiles are contemplated within the scope of the invention. Fort example, the number, size, corner types and/or angles of the tiers may be varied somewhat to produce a nonsymmetrical multi-tiered scoring edge profile within the scope of the present invention. Nevertheless, the specific scoring edge profile shown in FIGS. 5-8 is the presently preferred configuration.

The scoring edge 14 includes a central tier 30 that is typically symmetrical about the radial axis of symmetry 28. The central tier 30 includes a substantially axial surface. As used in this description, an “axial surface” means a surface that is substantially perpendicular to the radial axis of symmetry 28, and includes a strictly flat perpendicular surface as well as slightly arcuate and slightly beveled surfaces that are substantially axial in nature. The central tier 30 extends from the radial axis of symmetry 28 to a first flank 32. As used in this description, a “flank” is structure that includes a substantially radial surface (i.e., parallel to the radial axis of symmetry 28), and includes a strictly flat radial surface as well as slightly arcuate and slightly beveled surfaces that are substantially radial in nature. It should also be understood that the “tier” and “flank” structures may each include one or more corner or transition areas, so that the description of the tier “extending to” the flank includes a structure in which a rounded corner or other type of transition area bridges the junction from the substantially axial surface to the substantially radial surface.

The scoring edge 14 also includes first face 34 that extends from the first flank 32 to a second flank 36. Like the central tier 30, the first face 34 includes a substantially axial surface and may also include a corner or transition area. The scoring edge 14 also includes second face 38 that extends from the second flank 34 to a third flank 40. The second face 38 also includes a substantially axial surface and may also include a corner or transition area. The scoring edge 14 also includes a first beveled surface 42 that extends from the third flank 40 to the first radial edge 22. The first beveled surface 42 preferably slopes gently (e.g., at an angle less than 45°) with respect to the axial direction.

The preceding is a description of a symmetrical half of the scoring edge 14, going from the radial axis of symmetry 28 to the first radial edge 22. Accordingly, the opposing half of the scoring edge 14 is a corresponding symmetrical pair going from the radial axis of symmetry 28 to the second radial edge 24. Specifically, the central tier 30 extends from the radial axis of symmetry 28 to a fourth flank 44. The scoring edge 14 also includes third face 46 that extends from the fourth flank 44 to a fifth flank 48. The scoring edge 14 also includes fourth face 50 that extends from the fifth flank 48 to a sixth flank 52. The scoring edge 14 also includes a second beveled surface 54 that extends from the sixth flank 52 to the second radial edge 24. The second beveled surface 24 also slopes gently (e.g., at an angle less that 450) with respect to the axial direction.

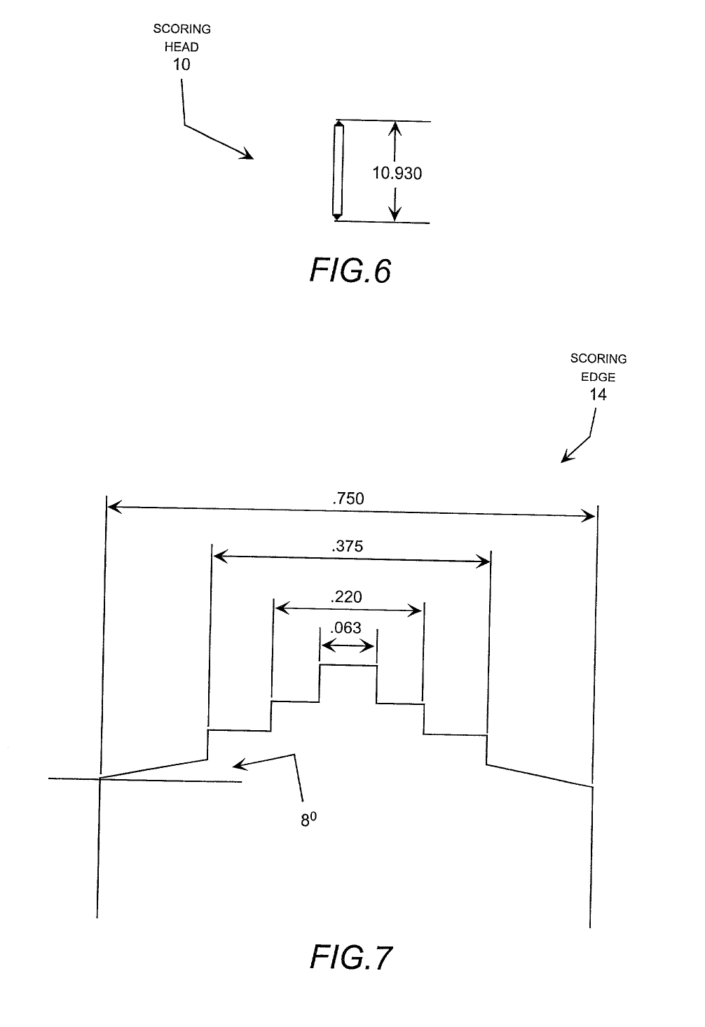

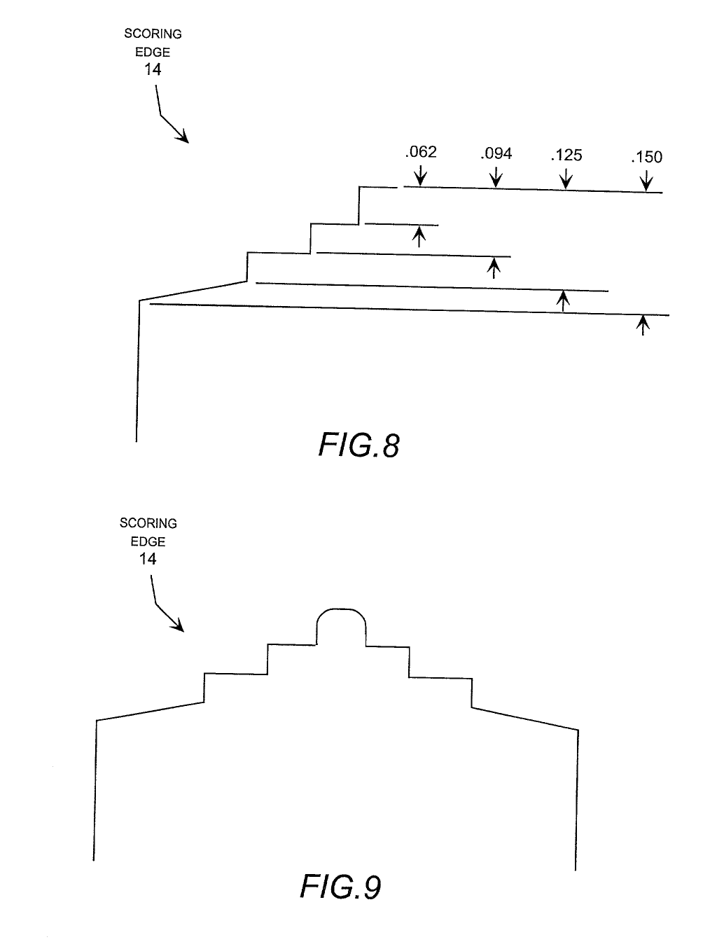

FIGS. 6-8 show the dimensions of a preferred scoring head 10 and scoring edge 14 with all dimensions states in inches. FIG. 6 is a front view of showing the height of a preferred scoring head 10, which is 10.930 inches. FIG. 7 is a front view of a preferred scoring head 10 showing dimensions defining the profile of the scoring edge 14. The following description will also refer to the elements shown on FIG. 5. Specifically, the distance from the first radial edge 22 to the second radial edge 24 is 0.750 inches, the distance from the third flank 40 to the sixth flank 52 is 0.375 inches, the distance from the second flank 36 to the fifth flank 48 is 0.220 inches, and the distance from the first flank 32 to the fourth flank 44 is 0.063 inches. FIG. 8 is a front view of the preferred scoring head 10 showing additional dimensions defining the profile of the scoring edge 14. Specifically, the distance from the central tier 30 to the first face 34 is 0.062 inches, the distance from the central tier 30 to the second face 38 is 0.094 inches, the distance from the central tier 30 to the axially inner end of the first beveled surface 42 is 0.125 inches, and the distance from the central tier 30 to the axially outer end of the first beveled surface 42 is 0.150 inches. The first and second beveled surfaces 42, 54 preferably slopes at an angle of approximately 80 with respect to the axial direction.

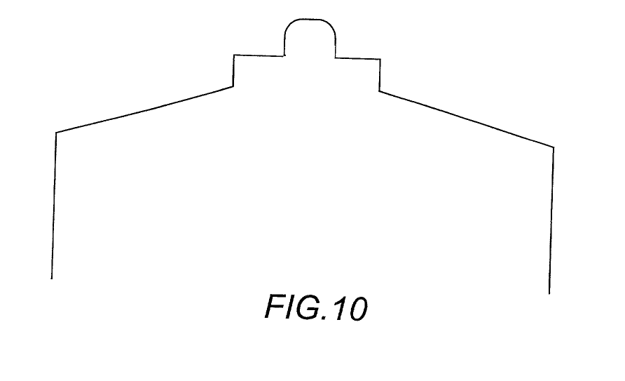

FIG. 9 is a front view of showing an alternative profile for a scoring edge 14. In particular, this alternative shown the central tier 30 including rounded corners. Similarly, the various faces and beveled surfaces could also include rounded corners. FIG. 10 is a front view of showing another alternative profile for a scoring edge 14. In particular, this alternative includes two rather than four axial faces. Many other alternatives and alterations within the scope and spirit of the present invention will become evident to those skilled in the art. Specifically, manufacturing can be simplified by rounding all of the corners of the scoring edge 14.

It has also been found that flanks having a slight reverse bevel (i.e., slightly decreasing axial offset with decreasing radial offset) are advantageous when scoring very dry board. For example, a typical embodiment of the scoring edge 14 includes a rounded central tier 30, rounded corners at the top and bottom of each or four flanks (i.e., two bilateral sets of faces), each flank having a slight reverse bevel, and first and second beveled surfaces 42, 54 sloping at an angle of approximately 80 with respect to the axial direction.

In view of the foregoing, it will be appreciated that present invention provides a greatly improved multi-tiered scoring head for creating crisp score lines in corrugated board of varying thickness. It should be understood that the foregoing relates only to the exemplary embodiments of the present invention, and that numerous changes may be made therein without departing from the spirit and scope of the invention as defined by the following claims.

The invention claimed is:

1. A scoring head configured for rotating about an axis of rotation and impressing score lines into corrugated board, the scoring head having a scoring edge extending axially between first and second radial edges, the scoring edge comprising:
a central tier extending axially from a central axis to a first flank;
a first face extending from the first flank to a second flank, the first face located radially closer to the axis of rotation than the central tier;
a second face extending from the second flank to a third flank, the second face located radially closer to the axis of rotation than the first face; and
a beveled surface extending from the third flank to the first radial edge.

2. The scoring head of claim 1, wherein the beveled surface is a first beveled surface, and the central tier extends axially from the central axis to a fourth flank, further comprising:
a third face extending from the fourth flank to a fifth flank, the third face located radially closer to the axis of rotation than the central tier;
a fourth face extending from the fifth flank to a sixth flank, the fourth face being located closer to the axis of rotation than the third face; and
a second beveled surface extending from the sixth flank to the second radial edge.

3. The scoring head of claim 2, wherein the central tier is symmetrical about the central axis.

4. The scoring head of claim 3, wherein the first and third faces form a first symmetrical pair about the central axis.

5. The scoring head of claim 4, wherein the second and fourth faces form a second symmetrical pair about the central axis.

6. The scoring head of claim 5, wherein the first and second beveled surfaces form a third symmetrical pair about the central axis.

7. The scoring head of claim 1, wherein the central tier defines a scoring surface that is substantially perpendicular to the central axis.

8. The scoring head of claim 1, wherein the first face defines a scoring surface that is substantially perpendicular to the central axis.

9. The scoring head of claim 2, wherein the second face defines a scoring surface that is substantially perpendicular to the central axis.

10. The scoring head of claim 1, wherein the third face defines a scoring surface that is substantially perpendicular to the central axis.

11. The scoring head of claim 2, wherein the fourth face defines a scoring surface that is substantially perpendicular to the central axis.

12. The scoring head of claim 1, wherein the first beveled surface slopes radially inward at about eight degrees with increasing offset from the central axis.

13. The scoring head of claim 2, wherein the second beveled surface slopes radially inward at about eight degrees with increasing offset from the central axis.

14. The scoring head of claim 1, wherein the first flank defines a substantially radial surface.

15. The scoring head of claim 1, wherein the second flank defines a substantially radial surface.

16. The scoring head of claim 1, wherein the third flank defines a substantially radial surface.

17. The scoring head of claim 2, wherein the fourth flank defines a substantially radial surface.

18. The scoring head of claim 2, wherein the fifth flank defines a substantially radial surface.

19. The scoring head of claim 2, wherein the sixth flank defines a substantially radial surface.

20. A scoring head configured for rotating about an axis of rotation and impressing score lines into corrugated board, the scoring head having a scoring edge extending axially between first and second radial edges, the scoring edge comprising:
a central tier extending axially from a central axis to a first flank defining a substantially radial surface, the central tier being symmetrical about the central axis;
a first face extending from the first flank to a second flank defining a substantially radial surface, the first face located radially closer to the axis of rotation than the central tier;
a second face extending from the second flank to a third flank defining a substantially radial surface, the second face located radially closer to the axis of rotation than the first face;
a first beveled surface extending from the third flank to the first radial edge;
the central tier extending axially from the central axis to a fourth flank defining a substantially radial surface;
a third face extending from the fourth flank to a fifth flank defining a substantially radial surface, the third face located radially closer to the axis of rotation than the central tier;
a fourth face extending from the fifth flank to a sixth flank defining a substantially radial surface, the fourth face being located closer to the axis of rotation than the third face;
a second beveled surface extending from the sixth flank to the second radial edge;
the central tier defining a scoring surface that is substantially perpendicular to the central axis;
the first face defining a scoring surface that is substantially perpendicular to the central axis;
the second face defining a scoring surface that is substantially perpendicular to the central axis;
the third face defining a scoring surface that is substantially perpendicular to the central axis; and
the fourth face defining a scoring surface that the substantially perpendicular to the central axis.

21. The scoring head of claim 20, wherein the first and second beveled surfaces slopes radially inward at about eight degrees with increasing offset from the central axis.

22. A scoring head configured for rotating about an axis of rotation and impressing score lines into corrugated board, the scoring head having a scoring edge extending axially between first and second radial edges, the scoring edge comprising:
a central tier extending axially from a central axis to a first flank defining a substantially radial surface, the central tier being symmetrical about the central axis;
a first face extending from the first flank to a second flank defining a substantially radial surface, the first face located radially closer to the axis of rotation than the central tier;
a first beveled surface extending from the second flank to the first radial edge;
the central tier extending axially from the central axis to a third flank defining a substantially radial surface;
a second face extending from the third flank to a fourth flank defining a substantially radial surface, the second face located radially closer to the axis of rotation than the central tier;
a second beveled surface extending from the fourth flank to the second radial edge;
the central tier defining a scoring surface that is substantially perpendicular to the central axis;
the first face defining a scoring surface that is substantially perpendicular to the central axis; and
the second face defining a scoring surface that is substantially perpendicular to the central axis.
